(19) United States
(12) Patent Application Publication
(10) Pub. No.: US 2010/0163512 A1
(43) Pub. Date: Jul. 1, 2010

(54) COMPOSITE SYNTHETIC CORK UTILIZING AN INTERLOCKING COMPONENT AND METHOD OF MANUFACTURE

(75) Inventor: Miguel F. Escobar, Mexico D.F. (MX)

Correspondence Address: CANTOR COLBURN, LLP, 20 Church Street, 22nd Floor, Hartford, CT, 06103, US

(73) Assignee: TAPONES ESCOBAR, S.A., Mexico, D.F. (MX)

(21) Appl. No.: 12/649,678

(22) Filed: Dec. 30, 2009

Related U.S. Application Data
(60) Provisional application No. 61/141,725, filed on Dec. 31, 2008.

(51) Int. Cl. B65D 39/00; B23P 17/00

(52) U.S. Cl. 215/364; 29/527.1

(57) ABSTRACT

A composite synthetic cork is provided, wherein the synthetic cork is operatively coupled with a decorative handle via an interlocking component. In an exemplary embodiment, the interlocking component is molded within an interior space of said synthetic cork component, such that the interlocking component is not readily apparent or not visible upon assembly with the decorative handle.

### CROSS-REFERENCE TO RELATED APPLICATIONS

The present application claims priority to U.S. Provisional patent application Ser. No. 61/141,725, filed Dec. 31, 2008; the entire contents of which are specifically incorporated by reference herein.

### BACKGROUND

The present disclosure relates to container closures using natural looking synthetic cork.

Producers of liquid consumable products, such as wine, liquor and other products, that are sold in bottles or other containers that are traditionally closed and sealed with cork stoppers have long been concerned about contamination due to the cork, which can lead to spoilage or alteration of the product within the container. In the case of wine or cooking oil, for example, such spoilage is immediately noticeable by the consumer and renders the product unfit for consumption.

For that reason, there has been a movement in recent times toward the use of synthetic stoppers in place of cork. If the synthetic materials used are non-reactive with the contents of the container, the synthetic stopper is a viable solution to the problem of contamination due to the cork, and consequently the contents of the container.

However, penetration of synthetic stoppers into the food and beverage container industry has been slow. Many producers of food and wine are reluctant to switch from traditional corks to synthetic stoppers for purely aesthetic reasons.

While synthetic stoppers generally exist in the marketplace, there is room in the industry for innovation, particularly as it relates to generating a more aesthetically appealing product.

### SUMMARY

The present invention comprises a composite synthetic cork, wherein the synthetic cork is operatively coupled with a decorative handle via an interlocking component. In an exemplary embodiment, the interlocking component is molded within an interior space of said synthetic cork component, such that the interlocking component is not readily apparent or not visible upon assembly with the decorative handle.

In other exemplary embodiments, the decorative handle comprises a transparent portion and an interior void, and the synthetic cork includes an aperture through a central portion of the cork, configured such that fluid from a stoppered container may pass through the cork and into the interior void, which is viewable through the transparent portion of the handle.

### BRIEF DESCRIPTION OF THE DRAWINGS

Referring now to the drawings, wherein like elements are numbered alike in the following FIGURES:

FIG. 1 is cross-sectional side view of an exemplary composite stopper;

FIG. 2 is a cross-sectional side view of an exemplary cork component and interlocking component;

FIG. 3 is a cross-sectional side view of an exemplary mold;

FIG. 4 is a cross-sectional side view of the exemplary mold of FIG. 3, wherein an interlocking component is installed prior to molding;

FIG. 5 is a cross-sectional side view of an exemplary mold for provision of an aperture through the cork and interlocking component;

FIG. 6 is a cross-sectional side view of an exemplary cork component and interlocking component including an aperture therethrough;

FIG. 7 is an exemplary composite stopper having an internal handle reservoir and an aperture through the cork stopper and interlocking component;

FIG. 8 is a cutaway perspective view of a complementary ridge in groove interface between the interlocking component and the cork; and

FIG. 9 is a non-cutaway perspective view of the cork of FIG. 8.

### DETAILED DESCRIPTION

As was noted above, the present disclosure relates to an improved composite synthetic cork, wherein the synthetic cork is operatively coupled with a decorative handle via an interlocking component.

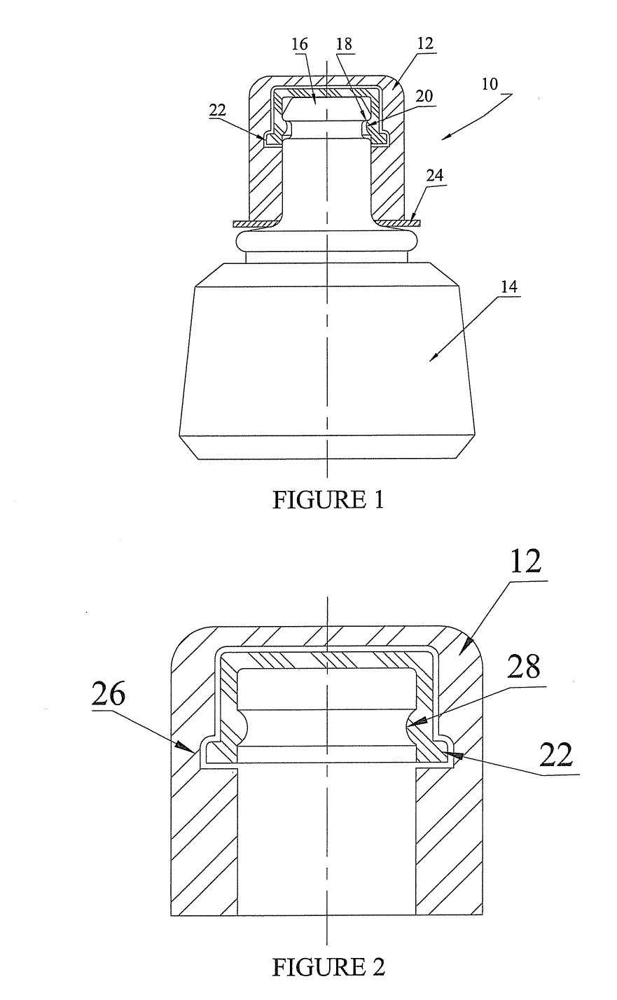

Referring now to FIG. 1, an exemplary improved composite synthetic cork is illustrated generally at 10. A synthetic cork portion 12 is joined to a decorative handle portion 14 at an exemplary neck 16 thereof. The neck portion includes an annular indent 18, into which a protruding portion 20 of the interlocking component 22 installs. In the exemplary embodiment illustrated in FIG. 1, a washer 24 is also installed in between the synthetic cork and the decorative handle. In exemplary embodiments, such washer may be used to prevent the handle (which may be, e.g., glass) from hitting the bottle (which also may be, e.g., glass).

FIG. 2 illustrates an exemplary exaggerated view of the synthetic cork portion 12 and interlocking component 22. As may be seen from the FIGURE, the interlocking component 22 nests within an inner aperture 26 of the synthetic cork portion 12 and itself includes a projection 28 that interfaces with the indent 18 of the handle neck 16. In exemplary embodiments, and depending on the materials used, the interlocking component 22 may fuse with the synthetic cork portion 12 during the molding process.

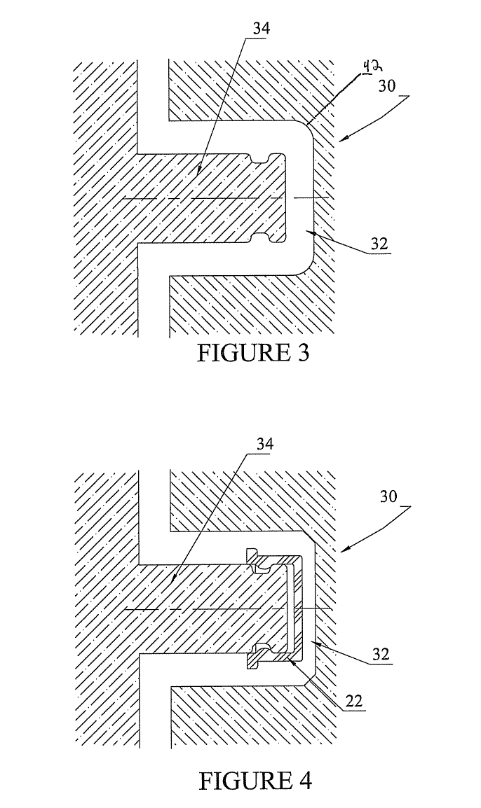

Referring now to FIG. 3, in an exemplary embodiment, the interlocking component may be installed into the synthetic cork component during formation of the synthetic cork portion. FIG. 3 illustrates an exemplary injection mold, shown generally at 30 that includes an interior region 32 for the synthetic cork and a mold projection 34 simulating the neck of the handle. It should be noted that the shape of the components and the mold are merely exemplary, and alterations in the shape are contemplated. For example, the mold could also include a straight or round chamfer to give a corresponding shape on the top of the cork (a rounded chamfer 42 is illustrated in FIG. 3 and a straight chamfer 44 is illustrated in FIG. 6).

In exemplary embodiments, the synthetic cork component and the interlocking component may be molded together, e.g. co-injected with the cork and the interlocking component having the same or different material qualities (in preferred exemplary embodiments, the interlocking component comprises a more rigid material, such as polyethylene, among others, to facilitate a secure grip on the handle). In other exemplary embodiments, the interlocking component and the synthetic cork component may be introduced in separate sequence (e.g., with the cork being introduced as a secondary operation).

The synthetic cork component may comprise any acceptable synthetic cork material, and the cork may be formed by any convenient mechanism, including such materials and mechanisms as are described in co-pending U.S. patent application Ser. No. 11/640,999, filed Dec. 19, 2006 and prior U.S. Provisional Application Ser. No. 60/751,299, the entire contents of each of which are specifically incorporated herein by reference (In short, these applications describe methods of creating the random and irregular markings including molding the details directly into the surface of the stopper and extruding the synthetic material into a desired shape before passing it through forming cylinders or rollers that contain the negative of the desired surface texture, and which imprint the texture onto the material's exterior surface).

With reference to FIG. 4, in other exemplary embodiments a separate interlocking component 22 may be placed over the projection 34 (by hand, by robot, etc.) prior to closing of the mold and injection of suitable material for the synthetic cork. In such case, the interlocking component 22 is molded within the cork, and the mold may be configured (as it is in the exemplary FIGURE) to completely conceal the interlocking component once the cork is installed on the handle.

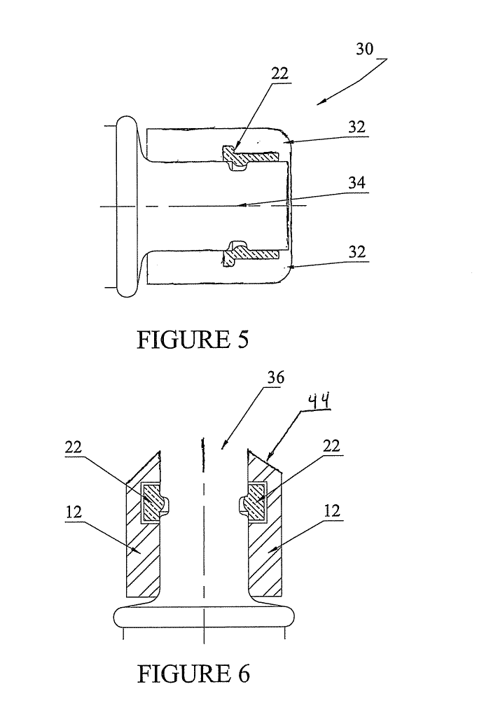

Referring now to FIGS. 5 and 6, in other exemplary embodiments, the cork and interlocking component may include an aperture 36 passing therethrough. Such aperture 36 may be formed in any convenient way (e.g., cut, bore, mold). FIG. 5 illustrates an exemplary mold 30, wherein the projection 34 is extended to create the aperture in the cork 32 and the interlocking component 22. If the interlocking component is a separate component that is installed in the mold over the projection 34, then the interlocking component may be pre-made including an aperture sized to permit the interlocking component to slide over the mold projection 34.

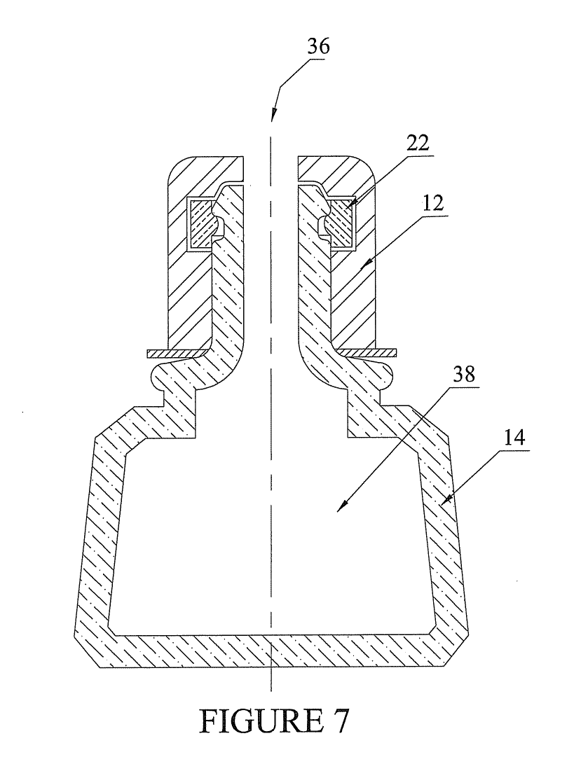

Referring to FIG. 7, in exemplary embodiments wherein the handle 14 includes an interior space 38, material from within a stoppered container (not shown) will be allowed to pass through the aperture 36 and into the interior space 38 of the handle 14. Thus, in exemplary embodiments wherein at least a portion of the handle 14 is at least partially transparent (e.g., non-opaque glass), the fluid may be seen within the handle if the bottle is tipped or upended. In exemplary embodiments, this feature also increases the head space in the bottle and makes for a better seal when the bottle is subjected to temperature changes.

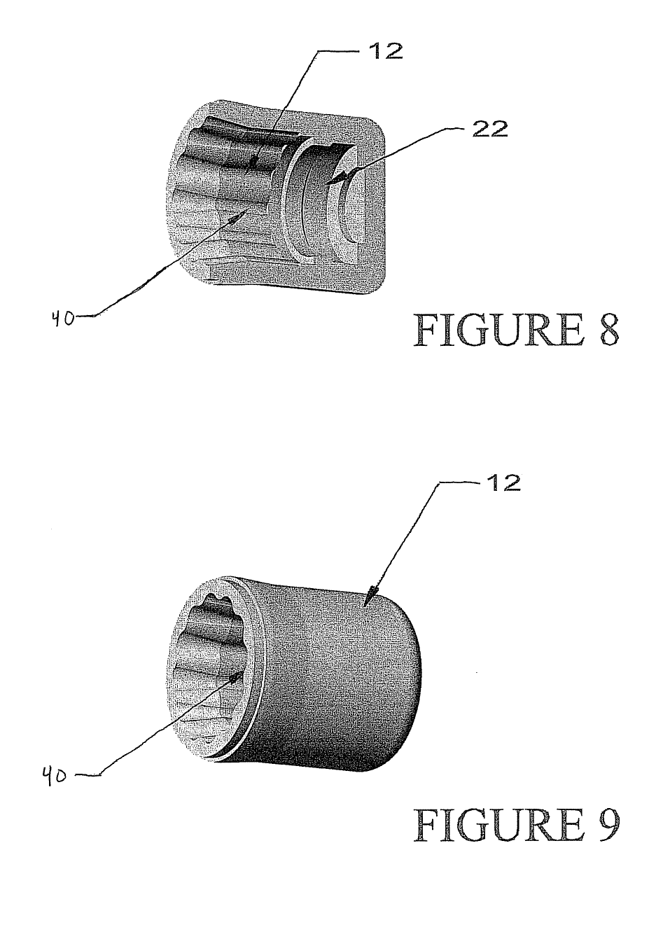

In other exemplary embodiments, the cork to handle interface may be constructed to prevent or resist rotation of the cork around the handle. For example, rather than using an annular projection in recess arrangement between the interlocking component and the handle, a pin in hole or elongated projection in recess configuration may be used. Also, interfering or friction ridges may be used on the cork interior space, wherein the ridges are configured to directly contact the handle to resist or prevent rotation. Further, the interface between the interlocking component 22 and the cork 12 may be stabilized (to prevent or resist rotation) using a complementary ridge in groove arrangement, such as is illustrated in FIGS. 8 and 9 at 40.

It will be apparent to those skilled in the art that, while exemplary embodiments have been shown and described, various modifications and variations can be made to the synthetic cork and method of making disclosed herein without departing from the spirit or scope of the invention. For example, recitations of projections and recesses on particular pieces are non-limiting, it being recognized that the arrangement may be reversed for a given piece. Accordingly, it is to be understood that the various embodiments have been described by way of illustration and not limitation.

What is claimed is:

1. A composite synthetic cork stopper, comprising:
a handle portion;
a synthetic cork stopper portion; and
an interlocking portion configured to mate the handle portion to the synthetic cork stopper portion, wherein the interlocking portion is provided within an interior portion of the synthetic cork stopper portion, such that when the synthetic cork stopper portion is placed on the handle portion, the interlocking portion is not visible.

2. A composite synthetic cork stopper in accordance with claim 1, wherein said interlocking portion includes a projection interfacing with a corresponding recess on said handle portion to retain said synthetic cork stopper portion on said handle portion.

3. A composite synthetic cork stopper in accordance with claim 1, wherein said handle portion includes a projection interfacing with a corresponding recess on said interlocking portion to retain said synthetic cork stopper portion on said handle portion.

4. A composite synthetic cork stopper in accordance with claim 2, wherein said projection comprises an annular projection, and wherein said recess comprises an annular recess.

5. A composite synthetic cork stopper in accordance with claim 1, wherein said interlocking portion is trapped within the material of said cork portion.

6. A composite synthetic cork stopper in accordance with claim 1, wherein said handle portion includes an interior reservoir, and wherein said interlocking portion and said cork stopper portion include an aperture provided in communication with said reservoir and an exterior surface of said cork stopper portion.

7. A composite synthetic cork stopper in accordance with claim 6, wherein at least a portion of said handle is transparent, such that any fluid within the reservoir may be viewed from outside the reservoir.

8. A composite synthetic cork stopper in accordance with claim 7, wherein at least a portion of said handle is glass.

9. A composite synthetic cork stopper in accordance with claim 1, wherein said cork stopper portion is configured to resist rotation around said handle when said cork stopper portion is installed over a portion of said handle.

10. A composite synthetic cork stopper in accordance with claim 9, wherein said interlocking component and said cork stopper portion resist rotation relative to one another due to a projection in recess or ridge in groove configuration.

11. A method of making a composite synthetic cork stopper, comprising:
molding an interlocking portion within a synthetic cork stopper material such that the interlocking portion is positioned in an interior space within said synthetic cork stopper material, the interlocking portion configured to retain said synthetic cork stopper material on a portion of a handle; and installation of said molded stopper material and interlocking portion over said portion of said handle.

12. A method in accordance with claim 11, wherein said interlocking piece is pre-loaded onto a mold protrusion approximating a handle portion before said synthetic cork stopper material is injected into said mold.

13. A method in accordance with claim 11, wherein said mold includes a projection approximating a handle portion, and wherein said projection includes an additional material configured to provide an aperture through said molded synthetic cork material and interlocking portion.

14. A method in accordance with claim 11, wherein said interlocking portion includes at least one projection or groove configured to provide rotational resistance relative to cured synthetic cork material that is injected thereover.
